(19) United States
(12) Patent Application Publication
(10) Pub. No.: US 2025/0266597 A1
(43) Pub. Date: Aug. 21, 2025

(54) FILTER AND COMMUNICATION DEVICE HAVING THE SAME

(71) Applicant: Telefonaktiebolaget LM Ericsson (publ), Stockholm (SE)

(72) Inventor: Jingpeng LI, Beijing (CN)

(21) Appl. No.: 18/845,251

(22) PCT Filed: May 18, 2022
(86) PCT No.: PCT/CN2022/093598

§ 371 Date: Sep. 9, 2024

(51) Int. Cl. H01P 1/207

(52) U.S. Cl. CPC H01P 1/207

(57) ABSTRACT

A filter includes a housing defining a cavity and a plurality of resonators in the cavity, wherein the plurality of resonators includes a first type resonator, the first type resonator includes a body that extends along a first direction, an enlarged portion that is provided at the top of the body and extends along a second direction substantially perpendicular to the first direction so as to have a larger width in the second direction than the body, and a protruding portion that is provided at an intermediate section of the body and extends from a lateral side of the body along the second direction, and an extended portion that extends at the top of the protruding portion along the first direction so as to have a larger width in the first direction than the protruding portion, wherein an input port and/or output port is connected to the protruding portion of the first type resonator.

### TECHNICAL FIELD

The present disclosure generally relates to components of communication device, and more particularly, to a filter and a communication device having the filter.

### BACKGROUND

This section introduces aspects that may facilitate better understanding of the present disclosure. Accordingly, the statements of this section are to be read in this light and are not to be understood as admissions about what is in the prior art or what is not in the prior art.

Base station (BS) is an important part of a mobile communication system, and may include a radio unit (RU) and an antenna unit (AU). Considering the installation/fixation/occupation, smaller volume and lighter weight is always an important evolution direction in BS design, including legacy base station, street macro, micro, small cell and advanced antenna system (AAS).

With the development of 5th Generation (5G) communication, Multiple-Input and Multiple-Output (MIMO) technology is widely used in Sub-6 GHz BS product, in which a large number of filters need to be integrated/embedded with AU or RU. The filter is an important part to build a multi-channel AAS. How to improve the radio performance of the filter, and how to reduce the size, weight, and cost of the filter are important for the radio performance.

Recent year, with the development of mobile communication system, the demands for small size and good radio performance are growing rapidly. To get size/weight and cost benefit and a good radio performance, small size metal filter is an irreplaceable solution. Small size metal filter is a better way to realize the small size/weight and has good performance, such as insertion loss and reliability.

A small size metal filter may comprise a plurality of resonators. The shape of the resonators has big influence on the performance of filter. In the current solution, it is discovered that the out of band spurious performance of the small size metal filter is not good enough. Therefore, a low pass filter is needed to inhibit the high band harmonic. The metal filter and the low pass filter are separated structures which require a large space and complex structure, which leads to low consistency and increased size and cost.

Therefore, there is a need to achieve better out of band spurious performance of the small size metal filter.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide a filter, which can achieve better out of band spurious performance.

According to a first aspect of the disclosure, there is provided a filter, comprises a housing defining a cavity, a plurality of resonators disposed in the cavity, input port, and output port, wherein the plurality of resonators comprises a first type resonator, the first type resonator comprises a body that extends along a first direction, an enlarged portion that is provided at the top of the body and extends along a second direction substantially perpendicular to the first direction so as to have a larger width in the second direction than the body, and a protruding portion that is provided at an intermediate section of the body and extends from a lateral side of the body along the second direction, and an extended portion that extends at the top of the protruding portion along the first direction so as to have a larger width in the first direction than the protruding portion, wherein at least one of the input port and the output port is connected to the protruding portion of the first type resonator.

In an embodiment of the disclosure, the distance from the bottom of the body to the top of the enlarged portion is less than half of the distance from the bottom of the body to the top of the protruding portion.

In an embodiment of the disclosure, the enlarged portion extends beyond two opposite lateral sides of the body.

In an embodiment of the disclosure, the enlarged portion extends beyond only one lateral side of the body, and the protruding portion extends beyond the same lateral side of the body or extend beyond the opposite lateral side of the body.

In an embodiment of the disclosure, the extended portion extends beyond only one lateral side of the protruding portion or extends beyond two opposite lateral sides of the protruding portion.

In an embodiment of the disclosure, the protruding portion is provided with a hollow-out portion.

In an embodiment of the disclosure, the first type resonator further comprises a second protruding portion that is provided at the intermediate section of the body and extends from another lateral side of the body along the second direction, and a second extended portion that extends at the top of the second protruding portion along the first direction so as to have a larger width in the first direction than the second protruding portion.

In an embodiment of the disclosure, the second extended portion extends beyond only one lateral side of the second protruding portion or extends beyond two opposite lateral sides of the second protruding portion.

In an embodiment of the disclosure, the plurality of resonators further comprises a second type resonator, the second type resonator comprising a body that extends along the first direction, and an enlarged portion that is provided at the top of the body and extends along the second direction so as to have a larger width in the second direction than the body, wherein the resonator which is not connected to the input port and the output port is the second type resonator.

In an embodiment of the disclosure, the filter further comprises a coupling part and an interior wall, the interior wall has a cross section generally in a T shape and divides the cavity into three chambers, the coupling part is arranged at a recessed portion of the interior wall.

In an embodiment of the disclosure, every two adjacent resonators are connected by a coupling structure.

In an embodiment of the disclosure, the plurality of resonators and the coupling structure are formed by an integrated structure.

In an embodiment of the disclosure, the housing, the plurality of resonators and the coupling structure are made of metal or non-metal base with a metallized surface.

According to a second aspect of the disclosure, there is provided a communication device, which comprises at least one filter according to the first aspect of the disclosure.

### BRIEF DESCRIPTION OF THE DRAWINGS

These and other objects, features and advantages of the disclosure will become apparent from the following detailed description of illustrative embodiments thereof, which are to be read in connection with the accompanying drawings, in which

FIG. 1 shows a filter according to an embodiment of the disclosure.

FIG. 2 shows a plurality of resonators in the filter according to an embodiment of the disclosure.

FIGS. 3A-3E show different variants of a first type resonator according to an embodiment of the disclosure.

FIG. 4 shows a first type resonator connected to an input port or output port according to an embodiment of the disclosure.

FIG. 5 shows a second type resonator according to an embodiment of the disclosure.

FIG. 6 shows a side view of electric field distribution of a first type resonator and a second type resonator according to an embodiment of the disclosure.

FIG. 7 shows the out of band spurious performance for a filter as shown in FIG. 1.

FIG. 8 shows the out of band spurious performance of a filter as shown in FIG. 1, but without the first type resonator.

### DETAILED DESCRIPTION

The embodiments of the present disclosure are described in detail with reference to the accompanying drawings. It should be understood that these embodiments are discussed only for the purpose of enabling those skilled in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. Those skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

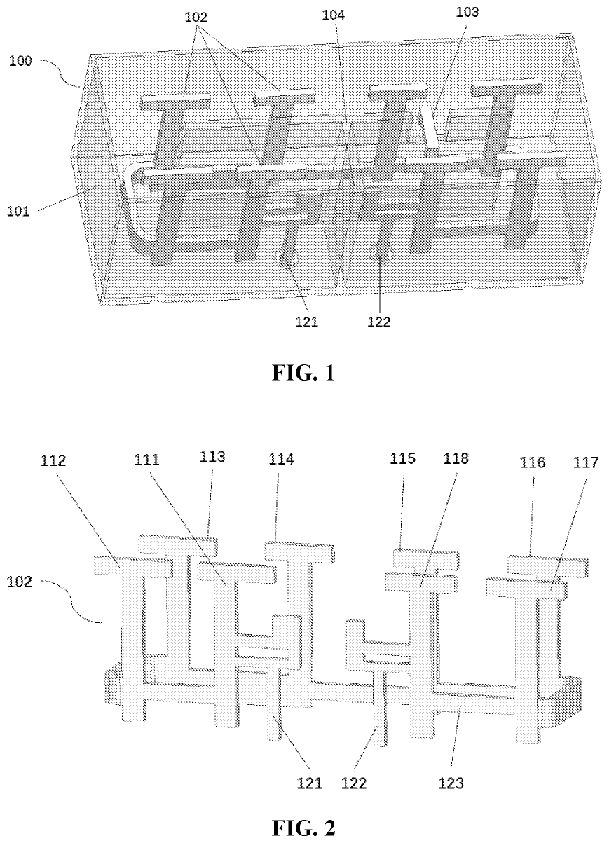

FIG. 1 shows a filter according to an embodiment of the disclosure. As shown in FIG. 1, the filter 100 comprises a housing 101 defining a cavity, a plurality of resonators 102 disposed in the cavity, input port 121, output port 122, a coupling part 103 and an interior wall 104.

The interior wall 104 has a cross section generally in a T shape, and divides the cavity into three chambers. The interior wall 104 separates the resonators in one of the three chambers from the resonators in the other two chamber, especially separating the resonator which is connected to the input port from the resonator which is connected to the output port. In this embodiment, the interior wall 104 is joined to the bottom inner surface of the housing 101 by e.g., soldering or welding. Alternatively, the interior wall 104 may be inserted into grooves that are formed in the bottom inner surface of the housing 101.

As shown in FIG. 1, at an upper position of the interior wall 104, a coupling part 103 is arranged at a recessed portion of the interior wall 104. The coupling part 103 serves to establish a cross-coupling between two resonators housed in different chambers.

FIG. 2 shows a plurality of resonators in the filter according to an embodiment of the disclosure. As shown in FIG. 2, a plurality of resonators comprises two first type resonators 111,118 and six second type resonators 112-117. Every two adjacent resonators are connected by a coupling structure 123. A first type resonator 111 is connected to the input port 121, another first type resonator 118 is connected to the output port 122, and the six second type resonators 112-117 are connected in series between the two first type resonators 111 and 118. Although it is shown in FIG. 1 and FIG. 2 that both of the input port 121 and the output port 122 are connected to first type resonator, an arrangement in which only one of the input port 121 and the output port 122 is connected to a first type resonator and the other of the input port 121 and the output port 122 is connected to a second type resonator is also feasible.

The shape and size of the first type resonator and the second type resonator can be set by a person skilled in the art according to specific application scenario, as long as the 2nd mode resonance frequency and electric field distribution of the first type resonator and the second type resonator are different, such that the coupling of the 2nd mode resonance for the two type resonators will decrease and better out of band spurious performance can be achieved. Furthermore, since the input port 121 and/or the output port 122 is connected to the protruding portion 203 which is located at an intermediate section of the body 201 of the first type resonator, there is a strong coupling to the 2nd mode resonance frequency. As a result, it will implement transmission zero at out of band to suppress high order resonance spurious of the second type resonator.

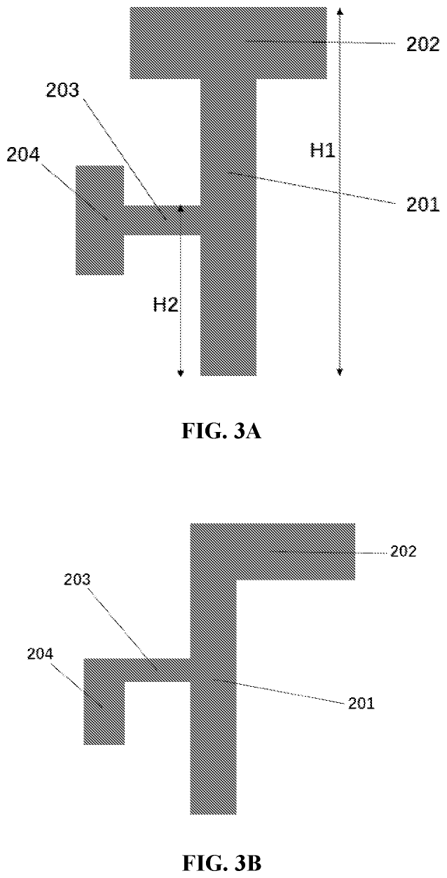

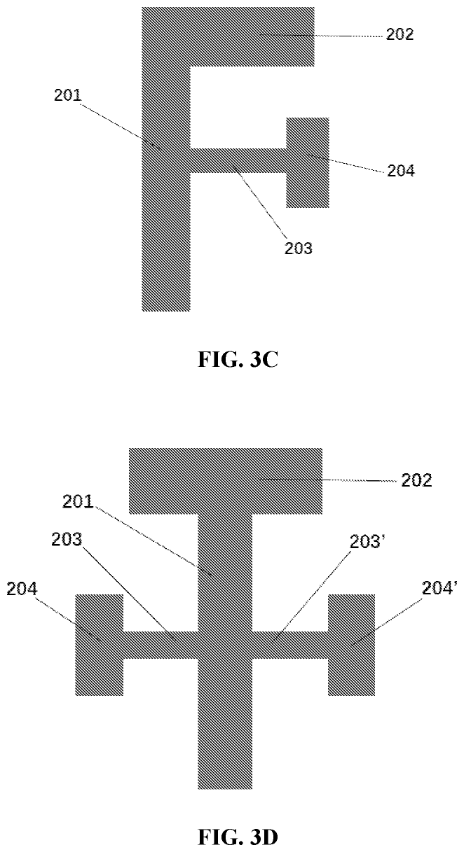

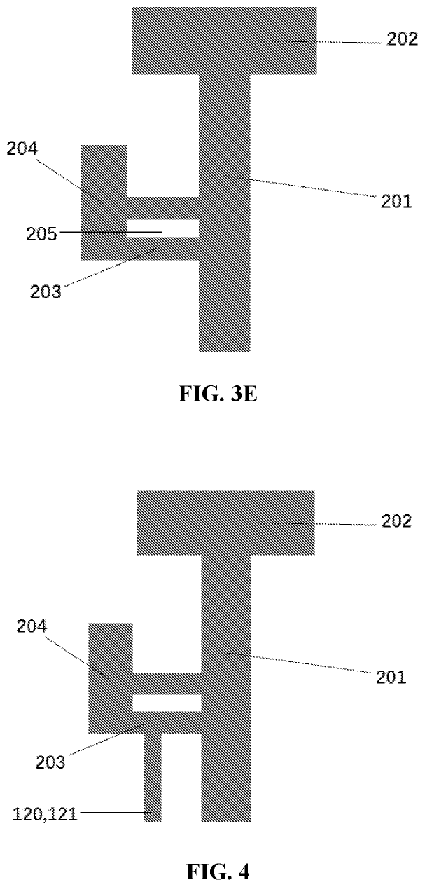

FIGS. 3A-3E show different variants of the first type resonator according to an embodiment of the disclosure.

As shown in FIG. 3A, the first type resonator comprises a body 201, an enlarged portion 202, a protruding portion 203 and an extended portion 204. The body 201 extends along a first direction. Preferably, the first direction is a direction extending along the length of the body 201. The enlarged portion 202 is provided at the top of the body 201 and extends along a second direction substantially perpendicular to the first direction so as to have a larger width in the second direction than the body 201. The protruding portion 203 is provided at an intermediate section of the body 201 and extends from a lateral side of the body 201 along the second direction. The extended portion 204 extends at the top of the protruding portion 203 along the first direction so as to have a larger width in the first direction than the protruding portion 203.

Preferably, the distance H2 from the bottom of the body 201 to the top of the enlarged portion 202 is less than half of the distance H1 from the bottom of the body 201 to the top of the protruding portion 203.

Moreover, the enlarged portion 202 extends beyond two opposite lateral sides of the body 201, and the extended portion 204 extends beyond two opposite lateral sides of the protruding portion 203.

The first type resonator shown in FIG. 3B differs from the resonator shown in FIG. 3A in that: the enlarged portion 202 extends beyond only one lateral side of the body 201, and the extended portion 204 extends beyond only one lateral side of the protruding portion 203.

The first type resonator shown in FIG. 3C differs from the resonator shown in FIG. 3A in that: the enlarged portion 202 extends beyond only one lateral side of the body 201, and the protruding portion 203 extends beyond the same lateral side of the body 201.

The first type resonator shown in FIG. 3D differs from the resonator shown in FIG. 3A in that: the first type resonator in FIG. 3D further comprises a second protruding portion 203′ that is provided at the intermediate section of the body 201 and extends from another lateral side of the body 201 along the second direction, and a second extended portion 204′ that extends at the top of the second protruding portion 203′ along the first direction so as to have a larger width in the first direction than the second protruding portion 203′. The second extended portion 204′ extends beyond two opposite lateral sides of the second protruding portion 203′.

The first type resonator shown in FIG. 3E differs from the resonator shown in FIG. 3A in that: the extended portion 204 extends beyond only one lateral side of the protruding portion 203, and the protruding portion 203 is provided with a hollow-out portion 205.

FIG. 4 shows a first type resonator connected to an input port or output port according to an embodiment of the disclosure. As shown in FIG. 4, when used in a filter, the protruding portion 203 is connected to an input port 120 or an output port 121.

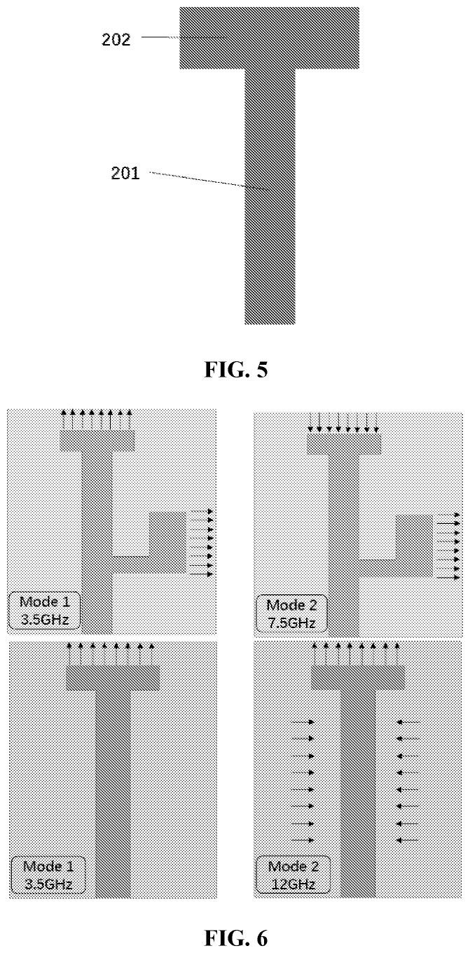

FIG. 5 shows a second type resonator according to an embodiment of the disclosure. As shown in FIG. 5, a second type resonator comprising a body 201 that extends along the first direction, and an enlarged portion 202 that is provided at the top of the body 201 and extends along the second direction so as to have a larger width in the second direction than the body 201. When used in a filter, the second type resonator is not connected to the input port and the output port.

FIG. 6 shows a side view of electric field distribution of a first type resonator and a second type resonator according to an embodiment of the disclosure. As shown in FIG. 6, the working frequency (Mode 1) of both of a first type resonator and a second type resonator is 3.5 GHz. The 2nd mode resonance frequency (Mode 2) of the first type resonator is 7.5 GHz, and the 2nd mode resonance frequency of the second type resonator is 12 GHz. Therefore, the first type resonator has much lower 2nd mode resonance frequency than the second type resonator. Moreover, as shown in FIG. 6, the electric field distribution of the first type resonator and the second type resonator are different. Therefore, since the 2nd mode resonance frequency and electric field distribution of the first type resonator and the second type resonator are different, the coupling of the 2nd mode resonance for the two type resonators will decrease and better out of band spurious performance can be achieved.

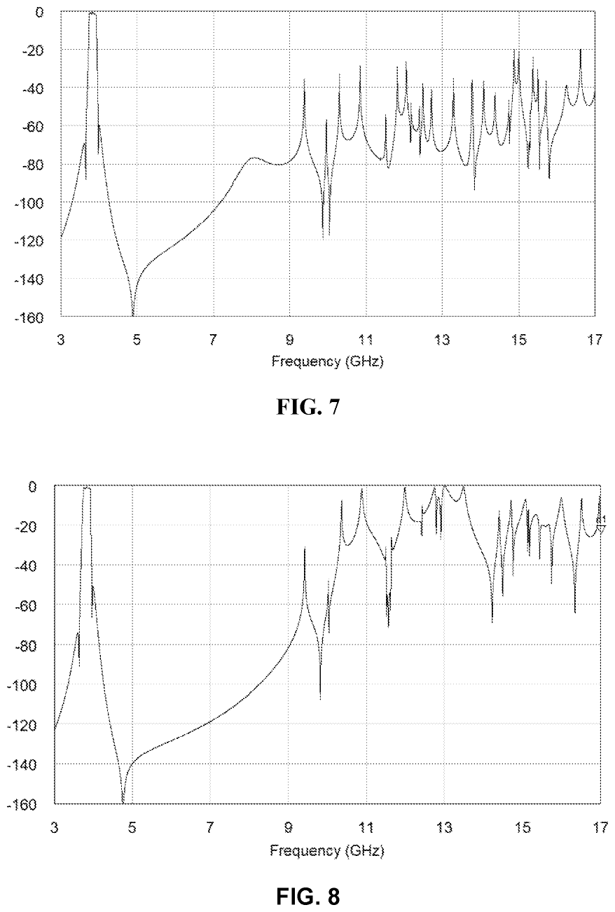

FIG. 7 shows the out of band spurious performance for a filter as shown in FIG. 1. As a comparison, FIG. 8 shows the out of band spurious performance of a filter as shown in FIG. 1, but without the first type resonator. As shown in FIG. 7 and FIG. 8, the signal amplitude of the high frequency region (from about 10 GHz to 17 GHz) in FIG. 7 is obviously lower than the signal amplitude of the same high frequency region in FIG. 8. Therefore, the out of band spurious performance of a filter comprising both the first type resonator and the second type resonator is obviously better than a filter only comprising the second type resonator.

Preferably, a plurality of resonators 111-118 and the coupling structure 123 are formed by an integrated structure, such that high integration and high reliability of filter can be achieved. More specifically, the plurality of resonators 111-118 and the coupling structure 123 are made of metal (such as aluminum, copper, iron and steel) or non-metal base with a metallized surface (such as a plastic base with sliver plated surface).

References in the present disclosure to “an embodiment”, “another embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A filter, comprises a housing defining a cavity, a plurality of resonators disposed in the cavity, input port, and output port, wherein the plurality of resonators comprises a first type resonator, the first type resonator comprises a body that extends along a first direction, an enlarged portion that is provided at the top of the body and extends along a second direction substantially perpendicular to the first direction so as to have a larger width in the second direction than the body, and a protruding portion that is provided at an intermediate section of the body and extends from a lateral side of the body along the second direction, and an extended portion that extends at the top of the protruding portion along the first direction so as to have a larger width in the first direction than the protruding portion, wherein at least one of the input port and the output port is connected to the protruding portion of the first type resonator.

2. The filter according to claim 1, wherein the distance from the bottom of the body to the top of the enlarged portion is less than half of the distance from the bottom of the body to the top of the protruding portion.

3. The filter according to claim 1, wherein the enlarged portion extends beyond two opposite lateral sides of the body.

4. The filter according to claim 1, wherein the enlarged portion extends beyond only one lateral side of the body, and the protruding portion extends beyond the same lateral side of the body or extend beyond the opposite lateral side of the body.

5. The filter according to claim 1, wherein the extended portion extends beyond only one lateral side of the protruding portion or extends beyond two opposite lateral sides of the protruding portion.

6. The filter according to claim 1, wherein the protruding portion is provided with a hollow-out portion.

7. The filter according to claim 1, wherein the first type resonator further comprises a second protruding portion that is provided at the intermediate section of the body and extends from another lateral side of the body along the second direction, and a second extended portion that extends at the top of the second protruding portion along the first direction so as to have a larger width in the first direction than the second protruding portion.

8. The filter according to claim 7, wherein the second extended portion extends beyond only one lateral side of the second protruding portion or extends beyond two opposite lateral sides of the second protruding portion.

9. The filter according to claim 1, wherein the plurality of resonators further comprises a second type resonator, the second type resonator comprising a body that extends along the first direction, and an enlarged portion that is provided at the top of the body and extends along the second direction so as to have a larger width in the second direction than the body, wherein the resonator which is not connected to the input port and the output port is the second type resonator.

10. The filter according to claim 1, wherein the filter further comprises a coupling part and an interior wall, the interior wall has a cross section generally in a T shape and divides the cavity into three chambers, the coupling part is arranged at a recessed portion of the interior wall.

11. The filter according to claim 1, wherein every two adjacent resonators are connected by a coupling structure.

12. The filter according to claim 11, wherein the plurality of resonators and the coupling structure are formed by an integrated structure.

13. The filter according to claim 12, wherein the housing, the plurality of resonators and the coupling structure are made of metal or non-metal base with a metallized surface.

14. A communication device, comprises at least one filter according to claim 1.
